(19) United States
(12) Patent Application Publication
(10) Pub. No.: US 2022/0341249 A1
(43) Pub. Date: Oct. 27, 2022

(54) VEHICLE CONTROL DEVICE, VEHICLE CONTROL METHOD, VEHICLE CONTROL SYSTEM, AND COMMUNICATION TERMINAL

(71) Applicant: TOYOTA JIDOSHA KABUSHIKI KAISHA, Toyota-shi (JP)

(72) Inventors: Yoshiya SUGITA, Toyota-shi (JP); Shutaro TOKUNAGA, Kariya-city (JP); Ryusuke ISHIKAWA, Kariya-city (JP)

(73) Assignee: TOYOTA JIDOSHA KABUSHIKI KAISHA, Toyota-shi (JP)

(21) Appl. No.: 17/659,400

(22) Filed: Apr. 15, 2022

(30) Foreign Application Priority Data
Apr. 26, 2021 (JP) 2021-074505

(51) Int. Cl. E05F 15/76; B60R 25/24; B60R 25/01

(52) U.S. Cl. CPC E05F 15/76; B60R 25/245; B60R 25/01; B60R 2325/205; E05Y 2400/40; E05Y 2400/66; E05Y 2900/546

(57) ABSTRACT

A vehicle control device that includes a memory and a processor coupled to the memory, and that controls driving of a vehicle door. The processor being configured to determine multiple times whether or not a communication terminal communicable with the vehicle control device is in a cabin-external region, which is a predetermined region external to a cabin of the vehicle, in a case in which a door switch of the vehicle door has been operated. The processor being configured to perform control to drive the vehicle door in accordance with the operation of the door switch in a case in which it has been determined at least one time or more, based on determination results, that the communication terminal is in the cabin-external region.

### CROSS-REFERENCE TO RELATED APPLICATION

This application is based on and claims priority under 35 USC 119 from Japanese Patent Application No. 2021-074505 filed on Apr. 26, 2021, the disclosure of which is incorporated by reference herein.

### BACKGROUND

### Technical Field

The present disclosure relates to a vehicle control device, a vehicle control method, a storage medium in which a vehicle control program is stored, a vehicle control system, and a communication terminal.

### Related Art

Conventionally, a vehicle opening/closing body control device that improves the convenience of reservations to close a door of a vehicle has been proposed (e.g., Japanese Patent Application Laid-open (JP-A) No. 2018-184728).

A door control device disclosed in JP-A No. 2018-184728 receives a reservation to close a sliding door provided in the vehicle. The door control device also determines whether or not an occupant of the vehicle is positioned in a determination area set to include the vicinity of the sliding door and, in a case where the occupant has moved outside the determination area after the door control device receives the reservation to close the door, executes control to close the sliding door and control to lock the door. The door control device furthermore measures the amount of time that elapses after it received the reservation to close the door. Then, in a case where the amount of elapsed time exceeds a predetermined amount of time, the door control device executes control to close the sliding door without executing control to lock the door.

The door control device disclosed in JP-A No. 2018-184728 determines whether or not the occupant of the vehicle is positioned in the determination area set to include the vicinity of the sliding door and receives a reservation to close the sliding door. It will be noted that the door control device disclosed in JP-A No. 2018-184728 determines whether or not the occupant of the vehicle is positioned in the determination area by performing a comparison determination utilizing wireless communication with a mobile device carried by the occupant of the vehicle.

However, the door control device of JP-A No. 2018-184728 is unable to receive the reservation to close the sliding door in a case where the occupant of the vehicle is not positioned in the determination area to begin with (e.g., see FIG. 1 of JP-A No. 2018-184728). For that reason, the technology disclosed in JP-A No. 2018-184728 has the problem that it cannot drive the vehicle door in a case where a communication terminal carried by a user who is the occupant is in a region where it is unable to communicate with an in-vehicle system when a door switch for driving the vehicle door has been operated.

The present disclosure has been made in view of the above circumstances, and inhibits the occurrence of a state in which a vehicle door is not driven even in a case where a communication terminal carried by a user is in a region where it is unable to communicate with an in-vehicle system when a door switch for driving the vehicle door has been operated.

### SUMMARY

In order to achieve the above object, a first aspect of the disclosure is a vehicle control device that controls the driving of a vehicle door, the vehicle control device including: a determination unit that determines multiple times whether or not a communication terminal communicable with the vehicle control device is in a cabin-external region, which is a predetermined region external to a cabin of the vehicle, in a case in which a door switch of the vehicle door has been operated; and a control unit that performs control to drive the vehicle door in accordance with the operation of the door switch in a case in which it has been determined at least one time or more, based on the results of the determinations by the determination unit, that the communication terminal is in the cabin-external region.

The determination unit of the vehicle control device of the first aspect of the disclosure determines multiple times whether or not the communication terminal communicable with the vehicle control device is in the cabin-external region, which is a predetermined region external to the cabin of the vehicle, in a case in which the door switch of the vehicle door has been operated. The control unit of the vehicle control device performs control to drive the vehicle door in accordance with the operation of the door switch in a case in which it has been determined at least one time or more, based on the results of the determinations by the determination unit, that the communication terminal is in the cabin-external region. Because of this, the occurrence of a state in which the vehicle door is not driven even in a case in which the communication terminal carried by a user is in a region where it is unable to communicate with an in-vehicle system when the door switch for driving the vehicle door has been operated can be inhibited.

The control unit of the vehicle control device of a second aspect of the disclosure performs control to not drive the vehicle door in a case in which it has been determined at least two times or more, based on the results of the determinations by the determination unit, that the communication terminal is not in the cabin-external region. According to the second aspect of the disclosure, the control unit performs control to not drive the vehicle door in a case in which it has been determined at least two times or more that the communication terminal is not in the cabin-external region, so inadvertent activation of the vehicle door can be inhibited.

The determination unit of the vehicle control device of a third aspect of the disclosure outputs a request signal multiple times to the communication terminal in predetermined time intervals in a case in which the door switch has been operated and determines that the communication terminal is in the cabin-external region in a case in which it has received at least one time or more a response signal output from the communication terminal in response to the request signal. According to the third aspect of the disclosure, the vehicle door can be driven in accordance with having received the response signal with respect to at least one or more request signals among the request signals output multiple times.

The determination unit of the vehicle control device of a fourth aspect of the disclosure outputs a request signal multiple times to the communication terminal in predetermined time intervals in a case in which the door switch has been operated and determines that the communication terminal is not in the cabin-external region in a case in which it has not received at least two times or more a response signal output from the communication terminal in response to the request signal. According to the fourth aspect of the disclosure, the control unit performs control to not drive the vehicle door in a case in which response signals with respect to at least two or more request signals among the request signals output multiple times have not been received, so inadvertent activation of the vehicle door can be inhibited.

The communication terminal of the vehicle control device of a fifth aspect of the disclosure is an electronic key carried by a user. According to the fifth aspect of the disclosure, the occurrence of a state in which the vehicle door is not driven even in a case in which the electronic key carried by the user is in the cabin-external region can be inhibited.

A sixth aspect of the disclosure is a vehicle control method executed by a vehicle control device that controls the driving of a vehicle door, the vehicle control method allowing the vehicle control device to execute a process to determine multiple times whether or not a communication terminal communicable with the vehicle control device is in a cabin-external region, which is a predetermined region external to a cabin of the vehicle, in a case in which a door switch of the vehicle door has been operated and perform control to drive the vehicle door in accordance with the operation of the door switch in a case in which it has been determined at least one time or more, based on the determination results, that the communication terminal is in the cabin-external region. According to the sixth aspect of the disclosure, as in the first aspect, the occurrence of a state in which the vehicle door is not driven even in a case in which the communication terminal carried by the user is in a region where it is unable to communicate with an in-vehicle system when the door switch for driving the vehicle door has been operated can be inhibited.

A seventh aspect of the disclosure is a storage medium in which is stored a vehicle control program for causing a computer configuring a vehicle control device that controls the driving of a vehicle door to execute a process to determine multiple times whether or not a communication terminal communicable with the vehicle control device is in a cabin-external region, which is a predetermined region external to a cabin of the vehicle, in a case in which a door switch of the vehicle door has been operated and perform control to drive the vehicle door in accordance with the operation of the door switch in a case in which it has been determined at least one time or more, based on the determination results, that the communication terminal is in the cabin-external region in predetermined time intervals. According to the seventh aspect of the disclosure, as in the first aspect, the occurrence of a state in which the vehicle door is not driven even in a case in which the communication terminal carried by the user is in a region where it is unable to communicate with an in-vehicle system when the door switch for driving the vehicle door has been operated can be inhibited.

An eighth aspect of the disclosure is a vehicle control system including the vehicle control device of any one of the first to fifth aspects and the communication terminal. According to the eighth aspect of the disclosure, as in the first aspect, the occurrence of a state in which the vehicle door is not driven even in a case in which the communication terminal carried by the user is in a region where it is unable to communicate with an in-vehicle system when the door switch for driving the vehicle door has been operated can be inhibited.

A ninth aspect of the disclosure is the vehicle control system, wherein the vehicle control device outputs a request signal multiple times to the communication terminal in predetermined time intervals in a case in which the door switch of the vehicle door has been operated, the communication terminal outputs to the vehicle control device a response signal in response to the request signal in a case in which it has received the request signal output from the vehicle control device, and the vehicle control device performs control to drive the vehicle door in accordance with the operation of the door switch in a case in which it has received the response signal output from the communication terminal. According to the ninth aspect of the disclosure, as in the first aspect, the occurrence of a state in which the vehicle door is not driven even in a case in which the communication terminal carried by the user is in a region where it is unable to communicate with an in-vehicle system when the door switch for driving the vehicle door has been operated can be inhibited.

A tenth aspect of the disclosure is a communication terminal in a vehicle control system including a vehicle control device that controls the driving of a vehicle door and a communication terminal communicable with the vehicle control device, wherein the vehicle control device outputs a request signal multiple times to the communication terminal in predetermined time intervals in a case in which a door switch of the vehicle door has been operated, the communication terminal outputs to the vehicle control device a response signal in response to the request signal in a case in which it has received the request signal output from the vehicle control device, and the vehicle control device performs control to drive the vehicle door in accordance with the operation of the door switch in a case in which it has received the response signal output from the communication terminal. According to the tenth aspect of the disclosure, as in the first aspect, the occurrence of a state in which the vehicle door is not driven even in a case in which the communication terminal carried by the user is in a region where it is unable to communicate with an in-vehicle system when the door switch for driving the vehicle door has been operated can be inhibited.

As described above, according to the present disclosure, there is obtained the advantageous effect that the occurrence of a state in which the vehicle door is not driven even in a case in which the communication terminal carried by the user is in a region where it is unable to communicate with the in-vehicle system when the door switch for driving the vehicle door has been operated can be inhibited.

### BRIEF DESCRIPTION OF DRAWINGS

FIG. 1 is a block diagram showing an example of the schematic configuration of a vehicle control system pertaining to an embodiment;

FIG. 2 is a block diagram showing an example of the schematic configuration of the vehicle control system pertaining to the embodiment;

FIG. 3 is a block diagram showing an example of functional configurations of an ECU pertaining to the embodiment;

FIG. 4 is a drawing for describing the embodiment;

FIG. 5 is a drawing for describing the embodiment;

FIG. 6 is a flowchart showing an example of a flow of processes performed by the ECU pertaining to the embodiment; and

FIG. 7 is a flowchart showing an example of a flow of processes performed by the ECU pertaining to the embodiment.

### DETAILED DESCRIPTION

An embodiment of the present disclosure will be described in detail below with reference to the drawings.

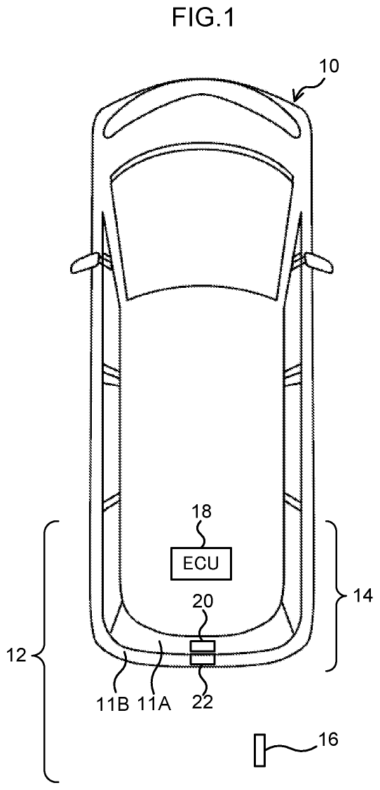

As shown in FIG. 1, a vehicle control system 12 of this embodiment is configured to include an in-vehicle system 14 and an electronic key 16 that is an example of a communication terminal carried by a user. The in-vehicle system 14 is installed in a vehicle 10. The vehicle 10 has a back door 11A in the rear portion of the vehicle and a rear bumper 11B.

The in-vehicle system 14 is configured to include an electronic control unit (ECU) 18 that is an example of a vehicle control device, a door switch 20, and an antenna 22. The ECU 18 is, for example, provided in a pillar in the rearmost portion of the vehicle 10. The configuration of the ECU 18 will be described later.

The door switch 20 is installed in the back door 11A and is pressed by the user when driving the back door 11A to close.

The antenna 22 sends to the electronic key 16 signals output from the ECU 18. The antenna 22 also outputs to the ECU 18 signals sent from the electronic key 16. The antenna 22 is, for example, installed inside the rear bumper 11B.

It will be noted that the in-vehicle system 14 further includes an electric drive unit (not shown in the drawings) and a door lock device (not shown in the drawings). The electric drive unit (not shown in the drawings) drives the back door 11A to open or drives the back door 11A to close. The door lock device locks the back door 11A.

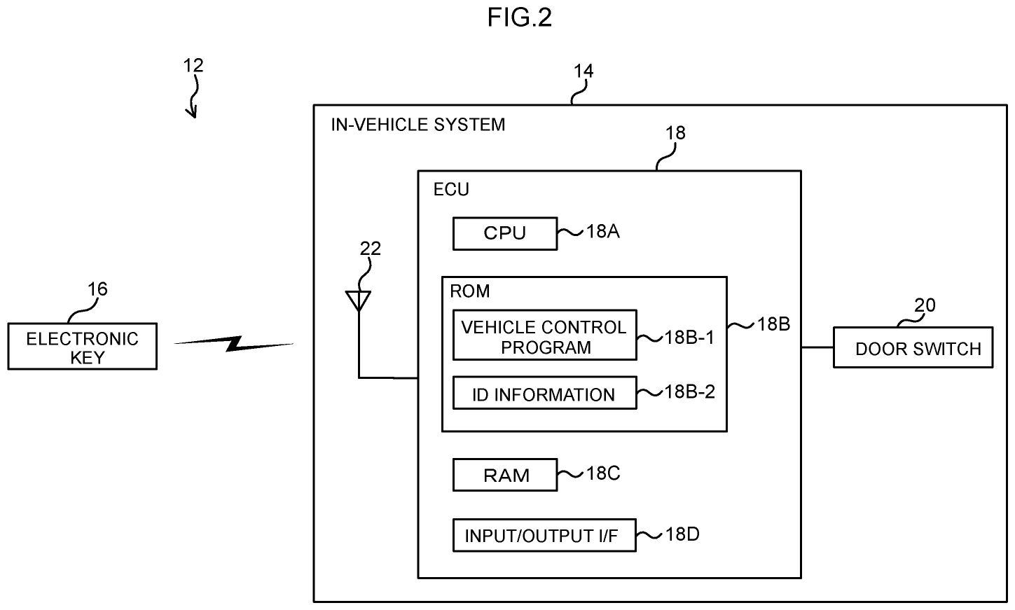

As shown in FIG. 2, the ECU 18 is configured to include a central processing unit (CPU) 18A, a read-only memory (ROM) 18B, a random-access memory (RAM) 18C, and an input/output interface (I/F) 18D. The CPU 18A, the ROM 18B, the RAM 18C, and the input/output I/F 18D are communicably connected to each other via an internal bus not shown in the drawings.

The CPU 18A is a central processing unit, executes various types of programs, and controls each part of the ECU 18. That is, the CPU 18A reads programs from the ROM 18B and executes the programs using the RANI 18C as a workspace.

The ROM 18B stores various types of programs and various types of data. In the ROM 18B of this embodiment, a vehicle control program 18B-1 is stored. The vehicle control program 18B-1 is a program for controlling the ECU 18. Also stored in the ROM 18B is ID information 18B-2 for executing a process to authenticate the electronic key 16.

The RAM 18C temporarily stores programs or data as a workspace. The input/output I/F 18D is an interface for communicating with the door switch 20, the antenna 22, the electric drive unit (not shown in the drawings), and the door lock device (not shown in the drawings).

It will be noted that the ECU 18 may also include a storage as a storage unit in addition to or instead of the ROM 18B. The storage is, for example, configured by a hard disk drive (HDD) or a solid-state drive (SSD).

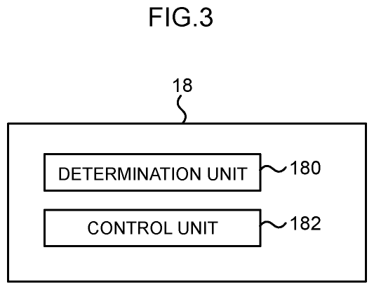

As shown in FIG. 3, in the ECU 18 of this embodiment, the CPU 18A functions as a determination unit 180 and a control unit 182 by executing the vehicle control program.

The electronic key 16 is an electronic device capable of being carried by the user of the vehicle 10. The electronic key 16 includes a microcomputer (not shown in the drawings) and a communication unit (not shown in the drawings). The microcomputer (not shown in the drawings) is configured to include at least a nonvolatile memory (not shown in the drawings). In the memory (not shown in the drawings) is stored ID information that is information unique to the electronic key 16. When the electronic key 16 receives a request signal output from the ECU 18, it outputs to the ECU 18 a response signal in response to the request signal.

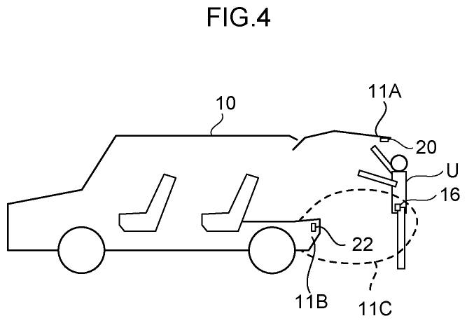

FIG. 4 is a drawing for describing the embodiment. As shown in FIG. 4, a user U presses the door switch 20 when he/she wants to close the back door 11A from a state in which the back door 11A is open. When the door switch 20 is pressed, an operation signal according to the operation is output to the ECU 18.

When the ECU 18 receives the operation signal, it outputs the request signal via the antenna 22 to the electronic key 16 carried by the user. When the electronic key 16 receives the request signal, it outputs to the ECU 18 the response signal in response to the request signal. The response signal includes, for example, the ID information relating to the electronic key 16. The ECU 18 receives via the antenna 22 the response signal sent from the electronic key 16. The ECU 18 compares the ID information included in the response signal to the ID information 18B-2 stored in the ROM 18B and determines whether or not the electronic key 16 is in a cabin-external region 11C that is a predetermined region external to the cabin of the vehicle 10. The cabin-external region 11C is a region in a range that the request signal output from the antenna 22 reaches.

The ECU 18 drives the back door 11A to close in accordance with the operation of the door switch 20 in a case where it has been determined, based on the determination results, that the electronic key 16 is in the cabin-external region 11C. Specifically, the ECU 18 outputs, to the electric drive unit (not shown in the drawings) for driving the back door 11A to close or driving the back door 11A to open, a control signal to drive the back door 11A to close. The electric drive unit (not shown in the drawings) drives the back door 11A to close in accordance with the control signal output from the ECU 18.

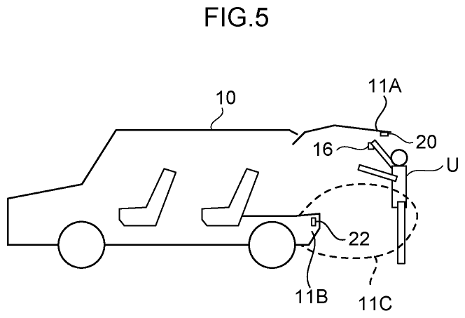

In this case, as shown in FIG. 4, the electronic key 16 is able to receive the request signal output from the antenna 22 in a case where the electronic key 16 carried by the user U is positioned in the cabin-external region 11C. In contrast, as shown in FIG. 5, the electronic key 16 is unable to receive the request signal output from the antenna 22 in a case where the electronic key 16 carried by the user U is not positioned in the cabin-external region 11C. In the example shown in FIG. 5, the user U is holding the electronic key 16 with the hand pressing the door switch 20. In such a case, the electronic key 16 is unable to receive the request signal output from the antenna 22 because the electronic key 16 is not positioned in the cabin-external region 11C. In addition, there are also cases where, due to some circumstance, the electronic key 16 is unable to receive the request signal output from the antenna 22. In such a case, the response signal is not output from the electronic key 16, and the ECU 18 does not receive the response signal. For that reason, the control signal is not output from the ECU 18 to the electric drive unit (not shown in the drawings), and so the back door 11A is not driven to close even though the user U has pressed the door switch 20.

Thus, the ECU 18 of the vehicle control system 12 of this embodiment determines multiple times whether or not the electronic key 16 is in the cabin-external region 11C in a case where the door switch 22 has been operated. Specifically, the ECU 18 outputs the request signal multiple times to the electronic key 16 in predetermined time intervals in a case where the door switch 22 has been operated. The ECU 18 outputs the request signal multiple times to the electronic key 16 by outputting the request signal each time a predetermined amount of time elapses in the predetermined time intervals. The ECU 18 determines that the electronic key 16 is in the cabin-external region 11C in a case where it has received at least one time or more the response signal in response to the request signal and drives the back door 11A to close in accordance with the determination results.

In the example shown in FIG. 5, at the moment when the user U presses the door switch 20, the electronic key 16 carried by the user U is not in the cabin-external region 11C. However, it is to be expected that the user U will lower the hand holding the electronic key 16 after the user U presses the door switch 20. Alternatively, it is to be expected that the user U will move his/her body, and it is to be expected that the user U will also move the hand holding the electronic key 16, after the user U presses the door switch 20.

In such a case, the likelihood is high that the electronic key 16 will be in the cabin-external region 11C after the door switch 20 has been operated. For this reason, the ECU 18 outputs the request signal multiple times to the electronic key 16 in the predetermined time intervals after the door switch 20 has been operated.

Because of this, the likelihood that the electronic key 16 will receive at least one or more request signals among the multiple request signals becomes higher. For that reason, there is a greater likelihood that the electronic key 16 will output to the ECU 18 the response signal in response to the request signal, and, as a result, the likelihood that the back door 11A will be driven to close becomes higher. Because of this, the occurrence of a state in which the back door 11A is not driven even in a case where the electronic key 16 carried by the user U is in a region where it is unable to communicate with the ECU 18 when the door switch 20 has been operated is inhibited.

The determination unit 180 determines multiple times whether or not the electronic key 16 is in the cabin-external region 11C in a case where the door switch 20 of the back door 11A has been operated. Specifically, the determination unit 180 outputs the request signal multiple times to the electronic key 16 in the predetermined time intervals in a case where the door switch 20 has been operated. For example, the determination unit 180 outputs the request signal multiple times to the electronic key 16 by outputting the request signal each time a predetermined amount of time elapses in the predetermined time intervals. The determination unit 180 determines that the electronic key 16 is in the cabin-external region 11C in a case where it has received at least one time or more the response signal output from the electronic key 16.

The control unit 182 performs control to drive the back door 11A in accordance with the operation of the door switch 20 in a case where it has been determined at least one time or more, based on the results of the determinations by the determination unit 180, that the electronic key 16 is in the cabin-external region 11C in the predetermined time intervals.

(Control Flow)

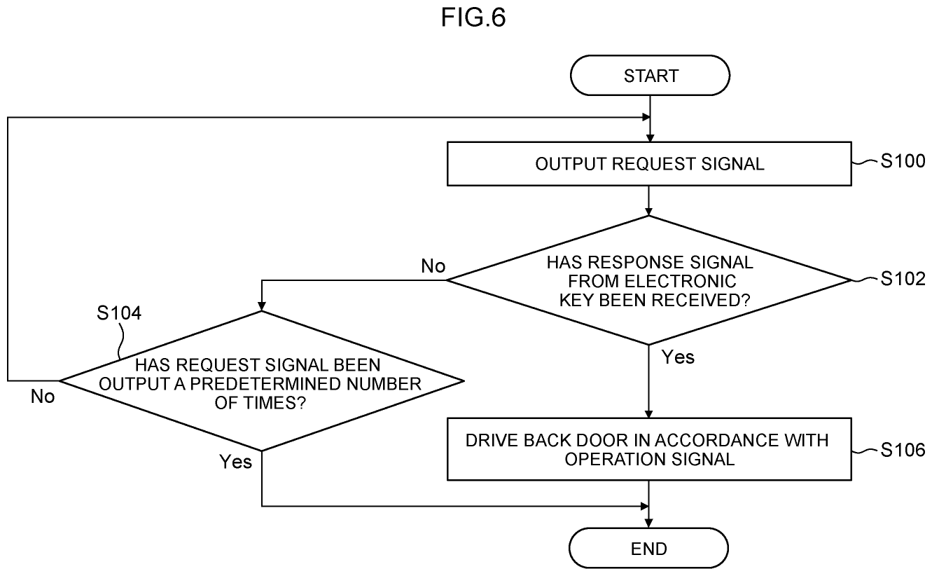

A flow of processes executed in the ECU 18 of this embodiment will now be described using the flowchart of FIG. 6. The processes in the ECU 18 are realized as a result of the CPU 18A functioning as the determination unit 180 and the control unit 182.

First, the operation signal is output from the door switch 20 as a result of the user pressing the door switch 20. When the CPU 18A of the ECU 18 receives the operation signal output from the door switch 20, it executes the flowchart of FIG. 6.

In step S100 the CPU 18A outputs the request signal to the electronic key 16.

In step S102 the CPU 18A determines whether or not the electronic key 16 is in the cabin-external region 11C by determining whether or not it has received the response signal from the electronic key 16. In a case where the CPU 18A has not received the response signal, it proceeds to step S104. In a case where the CPU 18A has received the response signal, it proceeds to step S106.

In step S104 the CPU 18A determines whether or not it has output the request signal a predetermined number of times to the electronic key 16. For example, the CPU 18A determines whether or not it has output the request signal five times to the electronic key 16. In a case where the CPU 18A has already output the request signal five times to the electronic key 16, it ends the process. In a case where the number of times that the CPU 18A has output the request signal to the electronic key 16 is less than five times, the CPU 18A returns to step S100 and again outputs the request signal.

The CPU 18A determines multiple times whether or not the electronic key 16 is in the cabin-external region 11C by executing the processes of step S102 and step S104.

In step S106 the CPU 18A performs control to drive the back door 11A to close in accordance with the operation signal of the door switch 20. Specifically, the CPU 18A drives the back door 11A to close by outputting a control signal to the electric drive unit (not shown in the drawings) of the back door 11A.

By executing the process of step S106, the CPU 18A performs control to drive the back door 11A in accordance with the operation of the door switch 20 in a case where it has been determined at least one time or more, based on the multiple determination results of whether or not the electronic key 16 is in the cabin-external region 11C, that the electronic key 16 is in the cabin-external region 11C.

It will be noted that after the back door 11A closes, it is locked by the door lock device (not shown in the drawings).

As described above, the ECU of the vehicle control system pertaining to the embodiment determines multiples times whether or not the electronic key communicable with the ECU is in the cabin-external region, which is a predetermined region external to the cabin of the vehicle, in a case where the door switch of the vehicle door has been operated. The ECU performs control to drive the vehicle door in accordance with the operation of the door switch in a case where it has been determined at least one time or more, based on the determination results, that the electronic key is in the cabin-external region. Because of this, the occurrence of a state in which the vehicle door is not driven even in a case where the communication terminal carried by the user is in a region where it is unable to communicate with the in-vehicle system when the door switch for driving the vehicle door has been operated can be inhibited.

Furthermore, even in a case where the in-vehicle system and the electronic key are unable to communicate with each other when the user has operated the door switch, the vehicle door can be driven when the in-vehicle system and the electronic key thereafter become able to communicate with each other.

In the above embodiment, a case where the vehicle door that is driven is the back door 11A in the rear portion of the vehicle was described as an example, but the vehicle door is not limited to this. For example, a vehicle door other than one in the rear portion of the vehicle, such as a vehicle door in the front portion of the vehicle, may also serve as the vehicle door that is driven.

Furthermore, in the above embodiment, a case where the door switch 20 is operated by the user and the ECU 18 determines multiple times whether or not the electronic key 16 is in the cabin-external region 11C in a situation of driving the back door 11A to close was described as an example, but the embodiment is not limited to this. For example, this embodiment may also be applied to a situation where the ECU 18 determines whether or not the electronic key 16 carried by the user is in the cabin-external region 11C after the ECU has received a reservation to drive the vehicle door closed based on an operation of the door switch 20 and executes control to drive the vehicle door to close and control to lock the vehicle door in a case where the electronic key 16 has moved outside the cabin-external region 11C.

Furthermore, in the above embodiment, a case where the communication terminal carried by the user is the electronic key 16 was described as an example, but the communication terminal is not limited to this. For example, a digital key may also be stored in a storage unit such as a smartphone carried by the user, and the ECU 18 may be configured to compare ID information relating to the digital key to the ID information 18B-2 stored in the ROM 18B of the ECU 18 and drive the vehicle door in accordance with the comparison result.

Furthermore, in the above embodiment, a case where the ECU 18 performs control to drive the back door 11A in accordance with the operation of the door switch 20 in a case where it has been determined at least one time or more that the electronic key 16 is in the cabin-external region 11C was described as an example, but the ECU 18 is not limited to this. For example, the ECU 18 may also be configured to perform control to not drive the vehicle door such as the back door 11A in a case where it has been determined at least two times or more that the electronic key 16 is not in the cabin-external region 11C. In this case, the ECU 18 outputs the request signal multiple times to the electronic key 16 in the predetermined time intervals in a case where the door switch 20 has been operated and determines that the electronic key 16 is not in the cabin-external region 11C in a case where it has not received at least two times or more the response signal output from the electronic key 16.

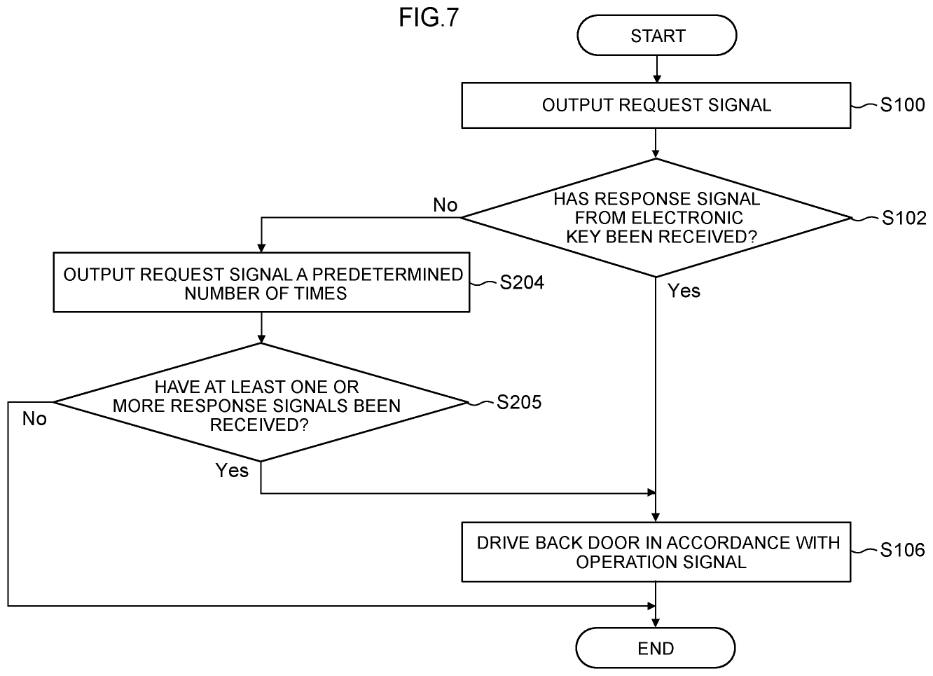

Furthermore, in the above embodiment, a case where the ECU 18 executes the flowchart of FIG. 6 was described as an example, but the ECU 18 is not limited to this. For example, the ECU 18 may also execute a flowchart such as shown in FIG. 7. In the flowchart shown in FIG. 7, the ECU 18 outputs the request signal multiple times to the electronic key 16 in a case where a response signal with respect to the output of the first request signal was not received. Additionally, the ECU 18 determines multiple times whether or not the electronic key 16 is in the cabin-external region 11C.

Specifically, in a case where, in step S102 of FIG. 7, the CPU 18A has not received the response signal from the electronic key 16, the CPU 18A proceeds to step S204.

In step S204 the CPU 18A outputs the request signal multiple times to the electronic key 16 in the predetermined time intervals. For example, the CPU 18A outputs the request signal five times to the electronic key 16.

In step S205 the CPU 18A determines whether or not it has received at least one or more response signals from the electronic key 16. In a case where the CPU 18A has received at least one or more response signals, it moves to step S106 and performs control to drive the back door 11A. In a case where the CPU 18A has not received a response signal, it ends the process. It will be noted that the processes of step S100 to step S102 and step S106 in FIG. 7 are executed in the same way as in FIG. 6.

The processes performed by the ECU 18 in each of the above embodiments were described as software processes performed by executing a program, but the processes may also be performed by hardware. Furthermore, the processes performed by the ECU 18 may also be performed by a combination of both software and hardware. Furthermore, the program stored in the ROM may also be stored in various types of storage media and circulated.

Furthermore, in each of the above embodiments, an example where the ECU 18 is configured by a microcomputer was described, but the ECU 18 is not limited to this. The functions of the ECU may also be realized by one microcomputer, and another ECU may also include any of the functions.

Moreover, the present disclosure is not limited to the above embodiments and can also be modified and implemented in various ways, in addition to the above embodiments, in a range that does not depart from the spirit thereof.

All publications, patent applications, and technical standards mentioned in this specification are herein incorporated by reference to the same extent as if each individual publication, patent application, or technical standard was specifically and individually indicated to be incorporated by reference.

What is claimed is:

1. A vehicle control device that includes a memory and a processor coupled to the memory, and that controls driving of a vehicle door,
the processor being configured to:
determine multiple times whether or not a communication terminal communicable with the vehicle control device is in a cabin-external region, which is a predetermined region external to a cabin of the vehicle, in a case in which a door switch of the vehicle door has been operated, and
perform control to drive the vehicle door in accordance with the operation of the door switch in a case in which it has been determined at least one time or more, based on determination results, that the communication terminal is in the cabin-external region.

2. The vehicle control device of claim 1, wherein the processor performs control to not drive the vehicle door in a case in which it has been determined at least two times or more, based on determination results, that the communication terminal is not in the cabin-external region.

3. The vehicle control device of claim 1, wherein the processor:
outputs a request signal multiple times to the communication terminal in predetermined time intervals in a case in which the door switch has been operated, and
determines that the communication terminal is in the cabin-external region in a case in which it has received, at least one time or more, a response signal output from the communication terminal in response to the request signal.

4. The vehicle control device of claim 2, wherein the processor:
outputs a request signal multiple times to the communication terminal in predetermined time intervals in a case in which the door switch has been operated, and
determines that the communication terminal is not in the cabin-external region in a case in which it has not received, at least two times or more, a response signal output from the communication terminal in response to the request signal.

5. The vehicle control device of claim 1, wherein the communication terminal is an electronic key carried by a user.

6. A vehicle control method executed by a vehicle control device that controls driving of a vehicle door,
the vehicle control method allowing a processor of the vehicle control device to execute a process to:
determine multiple times whether or not a communication terminal communicable with the vehicle control device is in a cabin-external region, which is a predetermined region external to a cabin of the vehicle, in a case in which a door switch of the vehicle door has been operated, and
perform control to drive the vehicle door in accordance with the operation of the door switch in a case in which it has been determined at least one time or more, based on determination results, that the communication terminal is in the cabin-external region.

7. A storage medium in which is stored a vehicle control program that controls driving of a vehicle door,
the vehicle control program causing a processor of a vehicle control device to execute a process to:
determine multiple times whether or not a communication terminal communicable with the vehicle control device is in a cabin-external region, which is a predetermined region external to a cabin of the vehicle, in a case in which a door switch of the vehicle door has been operated, and
perform control to drive the vehicle door in accordance with the operation of the door switch in a case in which it has been determined at least one time or more, based on determination results, that the communication terminal is in the cabin-external region in predetermined time intervals.

8. A vehicle control system including the vehicle control device of claim 1 and the communication terminal.

9. The vehicle control system of claim 8, wherein:
the processor of the vehicle control device outputs a request signal multiple times to the communication terminal in predetermined time intervals in a case in which the door switch of the vehicle door has been operated,
the communication terminal outputs, to the vehicle control device, a response signal in response to the request signal in a case in which it has received the request signal output from the vehicle control device, and
the processor of the vehicle control device performs control to drive the vehicle door in accordance with the operation of the door switch in a case in which it has received the response signal output from the communication terminal.

10. A communication terminal in a vehicle control system including a vehicle control device that controls driving of a vehicle door and the communication terminal, which is communicable with the vehicle control device,
wherein:
the communication terminal includes a communication terminal processor,
a processor with which the vehicle control device is equipped outputs a request signal multiple times to the communication terminal in predetermined time intervals in a case in which a door switch of the vehicle door has been operated,
the communication terminal processor of the communication terminal outputs, to the vehicle control device, a response signal in response to the request signal in a case in which it has received the request signal output from the processor of the vehicle control device, and
the processor of the vehicle control device performs control to drive the vehicle door in accordance with the operation of the door switch in a case in which it has received the response signal output from the communication terminal.
